(19) United States
(12) Patent Application Publication
(10) Pub. No.: US 2023/0286851 A1
(43) Pub. Date: Sep. 14, 2023

(54) METHOD FOR MANUFACTURING OPTICAL FIBER PREFORM

(71) Applicant: SUMITOMO ELECTRIC INDUSTRIES, LTD., Osaka-shi (JP)

(72) Inventors: Takahiro SAITO, Osaka-shi (JP); Hiroki INOUE, Osaka-shi (JP); Keisei MORITA, Osaka-shi (JP)

(73) Assignee: SUMITOMO ELECTRIC INDUSTRIES, LTD., Osaka-shi (JP)

(21) Appl. No.: 18/117,646

(22) Filed: Mar. 6, 2023

(30) Foreign Application Priority Data
Mar. 8, 2022 (JP) 2022-035119

(51) Int. Cl. C03B 37/014; C03B 37/012

(52) U.S. Cl. CPC C03B 37/01446; C03B 37/01211

(57) ABSTRACT

A method for manufacturing an optical fiber preform includes generating glass particles from a glass raw material gas in a flame obtained by combustion of a combustible gas supplied to a burner and depositing the glass particles on an outer circumference of a silica glass pipe to form a hollow porous glass preform, inserting a rod into the silica glass pipe, transparently vitrifying the porous glass preform by heating the porous glass preform after inserting the rod to obtain a transparent glass preform, drawing out the rod from the silica glass pipe after the porous glass preform is transparently vitrified, and removing the silica glass pipe from the transparent glass preform by etching after drawing out the rod.

### CROSS REFERENCE TO RELATED APPLICATIONS

This application claims priority based on Japanese Patent Application No. 2022-035119 filed on Mar. 8, 2022, the entire contents of which are incorporated herein by reference.

### TECHNICAL FIELD

The present disclosure relates to a method for manufacturing an optical fiber preform.

### BACKGROUND

Japanese Unexamined Patent Publication No. JP S63-222042 discloses a method for manufacturing an optical fiber preform. In this method, a central portion of a transparent glass body for a cladding is perforated to form a hollow portion, and a glass body for a core is inserted into the hollow portion and heated to be integrated.

### SUMMARY

The present disclosure relates to a method for manufacturing an optical fiber preform. The method includes generating glass particles from a glass raw material gas in a flame obtained by combustion of a combustible gas supplied to a burner and depositing the glass particles on an outer circumference of a silica glass pipe to form a hollow porous glass preform, inserting a rod into the silica glass pipe, transparently vitrifying the porous glass preform by heating the porous glass preform after inserting the rod to obtain a transparent glass preform, drawing out the rod from the silica glass pipe after the porous glass preform is transparently vitrified, and removing the silica glass pipe from the transparent glass preform by etching after drawing out the rod.

### BRIEF DESCRIPTION OF THE DRAWINGS

FIG. 1 is an exemplary cross-sectional view of an optical fiber preform manufactured by a manufacturing method according to one embodiment of the present disclosure.

FIG. 2A is a schematic view for explaining a method of manufacturing a transparent glass member for a cladding.

FIG. 2B is a schematic view for explaining the method of manufacturing the transparent glass member for the cladding.

FIG. 2C is a schematic view for explaining the method of manufacturing the transparent glass member for the cladding.

FIG. 2D is a schematic view for explaining the method of manufacturing the transparent glass member for the cladding.

FIG. 3 is a schematic view for explaining a step of removing a silica glass pipe from the transparent glass member for the cladding.

### DETAILED DESCRIPTION

### Problems to be Solved by Present Disclosure

In the manufacturing method of an optical fiber preform disclosed in JP S63-222042, a columnar transparent glass body for a cladding is manufactured, a hole is perforated in a central portion of the transparent glass body for the cladding by an ultrasonic perforator, and then the inside of the hole is etched with SF₆ to form a hollow-shaped transparent glass body for the cladding. However, if an attempt is made to form the hollow portion by etching in its entirety, a length and an inner diameter size that can be perforated are limited, and it is difficult to obtain, for example, a large-sized hollow-shaped transparent glass body. Also, since only a small optical fiber preform can be manufactured, manufacturing costs increase. Therefore, a manufacturing method in which manufacturing costs in manufacturing an optical fiber preform that is manufactured using a hollow-shaped transparent glass body can be reduced while the degree of freedom of manufacturing the optical fiber preform is improved, is desired.

### Effects of Present Disclosure

According to the present disclosure, manufacturing costs can be reduced in manufacturing an optical fiber preform while the degree of freedom of manufacturing is improved.

### DESCRIPTION OF EMBODIMENTS OF PRESENT DISCLOSURE

First, content of embodiments of the present disclosure will be listed and described. A method for manufacturing an optical fiber preform according to one embodiment of the present disclosure includes generating glass particles from a glass raw material gas in a flame obtained by combustion of a combustible gas supplied to a burner and depositing the glass particles on an outer circumference of a silica glass pipe to form a hollow porous glass preform, inserting a rod into the silica glass pipe, transparently vitrifying the porous glass preform by heating the porous glass preform after inserting the rod to obtain a transparent glass preform, drawing out the rod from the silica glass pipe after the porous glass preform is transparently vitrified, and removing the silica glass pipe from the transparent glass preform by etching after drawing out the rod.

In the method for manufacturing an optical fiber preform, the porous glass preform is formed on an outer circumference of the silica glass pipe and transparently vitrified, and the silica glass pipe is removed by etching to obtain a hollow-shaped transparent glass preform. In this case, a region of a hollow portion in the transparent glass preform is secured in advance by using the silica glass pipe, and moreover, a portion to be finally removed is reduced. Thus, the hollow-shaped transparent glass preform can be manufactured under relatively free manufacturing conditions without limiting a length or an inner diameter size of the hollow portion of the transparent glass preform. In addition, the porous grass preform is transparently vitrified after inserting the rod into the pipe in this method. Even if a wall thickness of the pipe is reduced, the rod prevents a diameter of the pipe from being reduced by sintering during the transparent vitrification in this method, and a desired inner diameter can be easily obtained. Thus, the wall thickness of the silica glass pipe can be reduced, and the pipe can be quickly and reliably removed in the removal step. According to the above method for manufacturing an optical fiber preform, the degree of freedom in manufacturing the optical fiber preform manufactured using the hollow-shaped glass sintered body can be improved, and a large-sized optical fiber preform can be manufactured, and thus manufacturing costs can be reduced. According to the above method, a large-sized hollow-shaped transparent glass preform can be easily obtained, and thus an optical fiber preform using the large-sized hollow-shaped transparent glass preform can be obtained.

As one embodiment, the silica glass pipe may have an outer diameter of 5 mm or more and 100 mm or less, and the silica glass pipe may have a wall thickness of 0.5 mm or more and 5 mm or less. When the outer diameter of the silica glass pipe is 5 mm or more, a sufficient deposition region of glass particles can be secured and a deposition rate can be improved. When the outer diameter of the silica glass pipe is 100 mm or less, occurrence of soot cracks in the deposited porous glass preform can be suppressed. When the wall thickness of the silica glass pipe is 0.5 mm or more, it is possible to prevent deformation of the pipe in depositing the glass particles. When the wall thickness of the silica glass pipe is 5 mm or less, a removal time of the pipe by etching can be reduced.

As one embodiment, an outer diameter of the rod may be 4 mm or more and may be smaller than an inner diameter of the silica glass pipe by 0.1 mm or more. When the outer diameter of the rod is 4 mm or more, a core with a larger size can be inserted to manufacture the optical fiber preform in a case in which the transparent glass preform is used as a transparent glass body for a cladding. When the outer diameter of the rod is smaller than the inner diameter of the silica glass pipe by 0.1 mm or more, insertion of the rod into the silica glass pipe and drawing the rod out of the silica glass pipe can be easily performed.

As one embodiment, the rod may be formed of a material having a melting point of 1500° C. or higher and a thermal expansion coefficient larger than 5×10⁻⁷/K. When the melting point of the material forming the rod is 1500° C. or higher, the rod can sufficiently withstand a temperature during sintering, and thereby deformation of the silica glass pipe can be prevented and a transparent glass preform having a desired inner diameter can be obtained. In addition, since the thermal expansion coefficient of the rod is larger than a thermal expansion coefficient of silica (5.0×10⁻⁷/K), and the rod contracts more than the silica glass pipe when the rod is drawn out from the silica glass pipe of the transparent glass preform heated by sintering, the rod can be easily drawn out.

As one embodiment, the rod may be formed of a material having a melting point of 1500° C. or higher and a thermal expansion coefficient larger than 1×10⁻⁶/K. In this case, since the thermal expansion coefficient of the rod is even larger than a thermal expansion coefficient of silica (5.0×10⁻⁷/K), and the rod contracts more than the silica glass pipe when the rod is drawn out from the silica glass pipe of the transparent glass preform heated by sintering, the rod can be more easily drawn out.

As one embodiment, the rod may be formed of one or more materials selected from alumina, carbon, silicon nitride, and silicon carbide. In this case, the rod can sufficiently withstand a temperature during sintering, and thereby deformation of the silica glass pipe can be prevented and a transparent glass preform having a desired inner diameter can be obtained. In addition, since the rod contracts more than the silica glass pipe when the rod is drawn out from the silica glass pipe of the transparent glass preform heated by sintering, the rod can be easily drawn out. Further, since these materials are available at a low cost, manufacturing costs can be reduced.

As one embodiment, the rod may have a first end and a second end opposite to the first end, and may have a tapered shape which becomes thinner from the second end toward the first end. The tapered shape of the rod may have an outer diameter which decreases in a range of 0.1 mm or more and 5 mm or less per 1000 mm from the second end toward the first end. Since the rod has a tapered shape, the rod can be easily drawn out when the rod is drawn out from the silica glass pipe after sintering. Further, when the diameter of the rod decreases in a range of 0.1 mm or more per 1000 mm from the second end toward the first end, sufficient drawability can be obtained. When the diameter of the rod decreases in a range of 5 mm or less per 1000 mm from the second end toward the first end, a rate of change in a longitudinal direction of a ratio between a diameter of the core portion (corresponding to an inner diameter of the transparent glass preform) and a diameter of the cladding portion (corresponding to an outer diameter of the transparent glass preform) in the optical fiber preform (or drawn-out optical fiber) can be caused to fall within an allowable range.

As one embodiment, the method for manufacturing an optical fiber preform may further include inserting a core portion made of glass into an inner hole of the transparent glass preform from which the silica glass pipe has been removed in the removal, and heating the transparent glass preform with the core portion to be integrated.

### DETAILS OF EMBODIMENTS OF PRESENT DISCLOSURE

A specific example of a method for manufacturing an optical fiber preform according to the present disclosure will be described below with reference to the drawings. The present invention is not limited to these examples but is indicated by the scope of the claims, and is intended to include all modifications within the meaning and scope equivalent to the scope of claims. The same elements will be denoted by the same reference signs in the description of the drawings, and duplicate description thereof will be omitted.

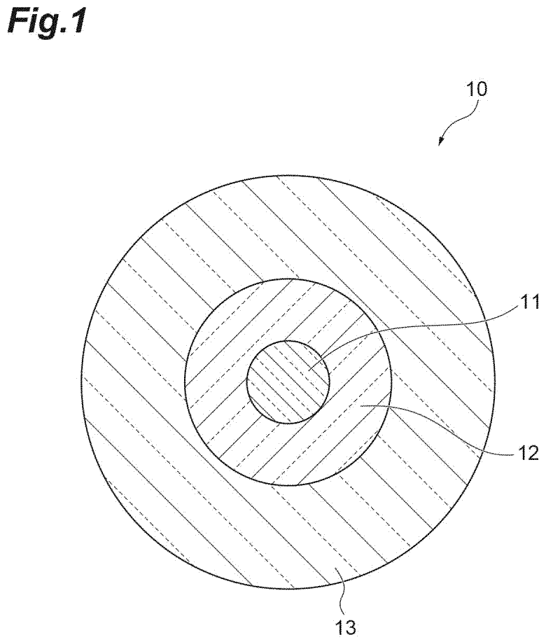

An example of an optical fiber preform manufactured by a manufacturing method according to one embodiment of the present disclosure will be described with reference to FIG. 1. An optical fiber preform 10 includes a core portion 11, a cladding portion 12, and a jacket portion 13 as illustrated in FIG. 1. The core portion 11 is made of, for example, silica-based glass. For example, at least one of germanium (Ge) and chlorine (Cl) is added to the core portion 11 to be configured to have a higher refractive index than the cladding portion 12. An alkali metal group may be added to the core portion 11. The cladding portion 12 is provided on an outer peripheral of the core portion 11 and configured to surround the core portion 11. The jacket portion 13 is provided on an outer peripheral of the cladding portion 12 and configured to surround the cladding portion 12. The cladding portion 12 and the jacket portion 13 are made of, for example, silica-based glass, and fluorine (F) may be added thereto. The jacket portion 13 functions as a second cladding portion, and is configured to have a refractive index slightly higher than that of the cladding portion 12 and lower than that of the core portion 11.

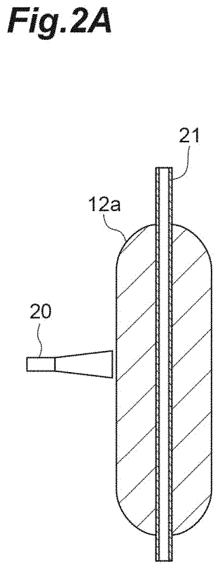

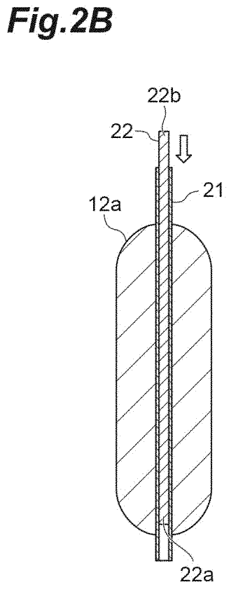

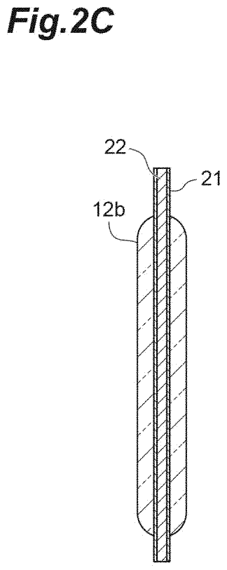

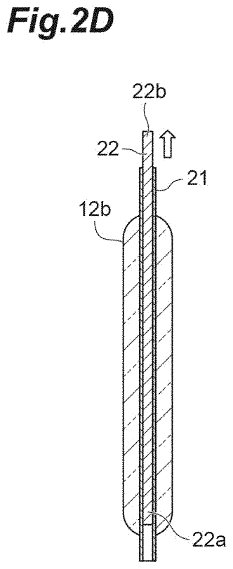

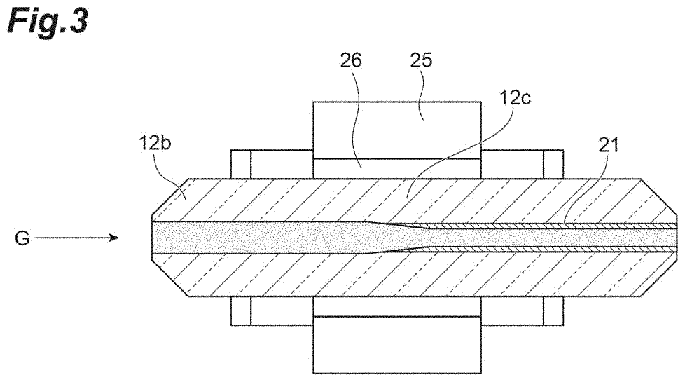

Next, with reference to FIGS. 2A to 2D and FIG. 3, a method for manufacturing a transparent glass preform corresponding to the cladding portion 12 of the optical fiber preform 10 will be described. Each of FIGS. 2A to 2D is a schematic view for explaining a method of manufacturing a transparent glass preform for a cladding. FIG. 3 is a schematic view for explaining a step of removing a silica glass pipe from the transparent glass preform for the cladding following FIGS. 2A to 2D. Further, a transparent glass preform for a core is inserted inside the hollow-shaped transparent glass preform for the cladding manufactured by the manufacturing method illustrated in FIGS. 2A to 2D and FIG. 3, and then the transparent glass preform for the core and the transparent glass preform for the cladding are heated and integrated. Then, the jacket portion 13 is further formed on an outer peripheral of the cladding portion 12 to form the optical fiber preform 10 illustrated in FIG. 1.

First, a method for manufacturing the transparent glass preform for the cladding will be described. The transparent glass preform for the cladding can be formed by, for example, using an Outside Vapor Deposition (OVD) method, and as illustrated in FIG. 2A, a glass particle deposit body 12a (porous glass preform) is manufactured using a burner installed laterally. In this step, the glass particle deposit body 12a is formed by rotating and vertically traversing a silica glass pipe 21 while depositing glass particles around the silica glass pipe 21, which functions as a target, by soot deposition. The glass particle deposit body 12a manufactured in this step corresponds to the cladding portion 12. More specifically, glass particles are generated from a glass raw material gas in a flame obtained by combustion of a combustible gas supplied to the burner 20, and the glass particles are deposited on an outer circumference of the silica glass pipe 21 to form the hollow glass particle deposit body 12a. An average bulk density of the glass particle deposit body 12a may be 0.2 g/cm³ or more and 1.0 g/cm³ or less, and is 0.3 g/cm³ as an example.

The silica glass pipe 21 used in the step of depositing the glass particle is a pipe made of silica glass (an example of a thermal expansion coefficient: 5.0×10⁻⁷/K). Chlorine (Cl) or fluorine (F) may be added to a silica glass used for the silica glass pipe 21. On the other hand, if OH radicals are mixed in the cladding portion 12, optical characteristics (for example, optical characteristics in optical communication with a wavelength of 1.38 μm) when the optical fiber preform 10 is drawn out to be an optical fiber deteriorate, and therefore OH radicals contained in the silica glass pipe 21 may be 1 ppm or less. Although a size of the silica glass pipe 21 is not particularly limited, for example, an outer diameter of the pipe may be 5 mm or more and 100 mm or less, and a wall thickness of the pipe may be 0.5 mm or more and 5 mm or less.

More specifically, in the step of depositing glass particle, glass particles are generated from a glass raw material gas in a flame obtained by combustion of a combustible gas (for example, hydrogen) supplied to the burner 20, and the glass particles are deposited to form the glass particle deposit body 12a. In addition to the combustible gas, a glass raw material gas (for example, SiCl₄) and oxygen (O₂) supplied from a gas supply system (not illustrated) is introduced into the burner 20. A gas (such as CF₄) for adding fluorine from the burner 20 may be added as necessary. Glass particles (SiO₂) are generated in the flame of the burner 20 by the following hydrolysis reaction and combustion reaction of the glass raw material gas, and the glass particles generated in the flame are sprayed onto the glass particle deposit body 12a from the burner 20.

SiCl₄+2H2O→SiO₂+4HCl

A method for manufacturing the glass particle deposit body 12a by the OVD method has been described in the above, but the glass particle deposit body 12a may be formed using a Vapor-phase Axial Deposition (VAD) method.

Next, when the soot deposition ends, a rod 22 is inserted into the silica glass pipe 21 as illustrated in FIG. 2B. The rod 22 is a columnar rod member that supports the silica glass pipe 21 from the inside, and has a first end 22a on a distal end side and a second end 22b opposite to the first end 22a. The rod 22 has an outer diameter slightly smaller than an inner diameter of the silica glass pipe 21 and is, for example, 4 mm or more. Thereby, the silica glass pipe 21 can be reliably supported from the inside. On the other hand, the rod 22 is formed smaller than the inner diameter of the silica glass pipe 21 by at least 0.1 mm because it is inserted into and drawn out from the silica glass pipe 21.

Since the rod 22 is used for sintering in the subsequent step of transparently vitrifying, the rod 22 is formed of a material having a melting point of 1500° C. or higher. In consideration of drawability after sintering, the rod 22 may be formed of a material having a thermal expansion coefficient larger than 5×10⁻⁷/K which is an example of a thermal expansion coefficient of silica, and may, as an example, be formed of a material having a thermal expansion coefficient larger than 1×10⁻⁶/K. Such a rod 22 is formed of one or more materials selected from, for example, alumina (thermal expansion coefficient: 7.2×10⁻⁶/K), carbon (thermal expansion coefficient: 4.7×10⁻⁶/K in a case of graphite), silicon nitride (thermal expansion coefficient: 2.8×10⁻⁶/K), and silicon carbide (thermal expansion coefficient: 3.7×10⁻⁶/K). The rod 22 is, for example, a rod made of high-purity graphite.

The rod 22 may have a columnar shape having the same outer diameter from the second end 22b toward the first end 22a, or may have a tapered shape in which an outer diameter decreases from the second end 22b toward the first end 22a. If the rod 22 has a tapered shape, it is possible to improve insertability into the silica glass pipe 21 and drawability from the silica glass pipe 21. If the rod 22 has a tapered shape, the rod 22 may have a shape in which an outer diameter thereof decreases in a range of 0.1 mm or more and 5 mm or less per a rod length of 1000 mm from the second end 22b toward the first end 22a. Although the step of inserting is performed after the step of depositing glass particles in the above, the step of inserting can be performed before the step of depositing glass particles and glass particles may be deposited on the outer circumference of the silica glass pipe 21 with the rod 22 inserted into the silica glass pipe 21.

Next, when the rod 22 has been inserted into the silica glass pipe 21, as illustrated in FIG. 2C, the glass particle deposit body 12a deposited on the outer circumference of the silica glass pipe 21 is heated and transparently vitrified to obtain a glass sintered body 12b. In the step of transparently vitrifying, a temperature of the glass particle deposit body 12a is raised from a furnace temperature of about 1000° C. to about 1200° C., and a dehydration treatment is performed in a mixed atmosphere of chlorine and helium. As an example, a mixed gas of chlorine of 10% by volume (with a flow rate of 1 slm) and helium is introduced into a furnace at a furnace temperature of 1150° C., and a dehydration treatment is performed on the glass particle deposit body 12a in a chlorine atmosphere. OH radicals in the glass particle deposit body 12a are removed by the dehydration treatment.

When the dehydration treatment ends, the furnace temperature is raised to 1300° C., a mixed gas of silicon tetrafluoride (SiF₄) of 10% by volume and helium is introduced into the furnace, and fluorine is added in this atmosphere. Thereby, fluorine is added to the glass particle deposit body 12a. Thereafter, the furnace temperature is further raised to 1500° C., and sintering is performed in a helium atmosphere. A flow rate of introducing helium during sintering is, for example, 10 slm. Due to such sintering, the glass particle deposit body 12a is sintered and transparently vitrified, and becomes the hollow-shaped glass sintered body 12b. In the step of transparently vitrifying, heating by a heater may be performed by traversing downward while rotating the glass particle deposit body 12a. Although a diameter of the glass particle deposit body 12a is reduced by the temperature rise in the step of transparently vitrifying (especially, in the step of sintering), since the rod 22 supports the silica glass pipe 21 from the inside, the diameter of the silica glass pipe 21 being reduced (the inner diameter of the glass particle deposit 12a being reduced) is prevented.

Next, when sintering in the step of transparently vitrifying ends, the rod 22 is drawn out from the silica glass pipe 21 as illustrated in FIG. 2D. At this time, when the rod 22 has a tapered shape, has an outer diameter smaller than an inner diameter of the silica glass pipe 21, is formed of a material having a larger thermal expansion coefficient than the silica glass pipe 21, or the like, the rod 22 can be easily drawn out from the silica glass pipe 21. Due to the step of drawing out, the glass sintered body 12b from which the rod 22 has been removed is obtained.

Next, when the rod 22 is drawn out from the silica glass pipe 21, a portion of the silica glass pipe 21 is removed from the glass sintered body 12b by etching as illustrated in FIG. 3. In the step of removing, the glass sintered body 12b inside which the silica glass pipe 21 is fixed is mounted on an induction furnace lathe 25. The induction furnace lathe 25 has a heater 26. Then, an etching gas G is introduced into the silica glass pipe 21 from a direction indicated by the arrow in the drawing while heating the glass sintered body 12b mounted on the induction furnace lathe 25 at a furnace temperature of about 2000° C. by the heater 26. The introduced etching gas G is, for example, a fluorine gas and is sulfur hexafluoride (SF₆) as an example. Other etching gases may be used. A flow rate of introducing the etching gas G may be about 1 slm, and etching may be performed while traversing the induction furnace lathe 25 in a longitudinal direction of the preform. A traverse speed in this case is, for example, about 6 mm/min. By such etching, the silica glass pipe 21 of a heated portion 12c that is heated in the glass sintered body 12b is gradually removed. As described above, the transparent glass preform for the cladding corresponding to the cladding portion 12 can be obtained.

Next, a core portion (a transparent glass preform for core) made of glass is inserted into an inner hole of the transparent glass preform from which the silica glass pipe 21 has been removed in the step of removing, and is heated to be integrated. In the step of integrating, a core pipe corresponding to the separately manufactured core portion 11 is inserted inside the transparent glass preform for the cladding. Then, the furnace temperature is raised to about 2000° C., a differential pressure in the pipe is set to about −10 kPa, and collapsing is performed at a traverse speed of 10 mm/min Thereby, a core cladding in which the core portion 11 and the cladding portion 12 are integrated is formed.

Next, when the core cladding is formed, this preform is extended to a desired length, and a portion corresponding to the jacket portion 13 is subjected to soot deposition by the VAD method and sintered, thereby obtaining the optical fiber preform 10 illustrated in FIG. 1. Further, conventional methods can be used for the step of integrating in which collapsing is performed and the step of manufacturing a jacket, and therefore detailed description thereof will be omitted here.

As described above, in the method for manufacturing an optical fiber preform according to the present embodiment, the glass particle deposit body 12a is formed on an outer circumference of the silica glass pipe 21 and transparently vitrified, and the silica glass pipe 21 is removed by etching to obtain the glass sintered body 12b which is a hollow-shaped transparent glass preform. In this case, when the silica glass pipe 21 is used, a region of a hollow portion in the glass sintered body 12b is secured in advance, and moreover, a portion to be finally removed is reduced. Thus, the hollow-shaped glass sintered body 12b can be manufactured under relatively free manufacturing conditions without limiting a length or an inner diameter size of the hollow portion of the glass sintered body 12b. In addition, in the method for manufacturing an optical fiber preform, the step of transparently vitrifying is performed after inserting the rod 22 into the silica glass pipe 21. In this case, even if a wall thickness of the silica glass pipe 21 is reduced, the rod 22 prevents a diameter of the silica glass pipe 21 from being reduced by sintering during the transparent vitrification, and a desired inner diameter can be easily obtained. Thus, the wall thickness of the silica glass pipe 21 can be reduced, and the pipe can be quickly and reliably removed in the step of removing. According to the method for manufacturing an optical fiber preform, since the degree of freedom in manufacturing the optical fiber preform 10 manufactured using the hollow-shaped glass sintered body 12b can be improved, and a large-sized optical fiber preform can be manufactured, manufacturing costs can be reduced. According to the manufacturing method, since the large-sized hollow-shaped glass sintered body 12b can be easily obtained, the optical fiber preform 10 using the large-sized hollow-shaped glass sintered body 12b can be obtained.

While the embodiment of the present disclosure has been described in detail above, the present invention is not limited to the above-described embodiment and can be applied to various embodiments.

### EXAMPLE

Hereinafter, the present disclosure will be described more specifically with reference to an example. However, the present invention is not limited to the following example.

In the present example, a hollow transparent glass preform according to the above-described embodiment is manufactured and used to manufacture an optical fiber preform. First, in the step of depositing glass particles, the silica glass pipe 21 having an outer diameter of 40 mm and a wall thickness of 1.5 mm is prepared, and soot deposition is performed for the silica glass pipe 21 by the OVD method. An average bulk density of the soot-deposited glass particle deposit body 12a is 0.3 g/cm³, and a size thereof is 250 mm in outer diameter and 1000 mm in length.

Next, the rod 22 made of high-purity graphite having an outer diameter of 36 mm is inserted into the silica glass pipe 21 of the glass particle deposit body 12a described above, and the step of transparently vitrifying (dehydration and sintering) is performed. In the step of transparently vitrifying, first, a mixed gas of chlorine of 10% by volume (flow rate: 1 slm) and helium is introduced at a furnace temperature of 1000° C. to perform a dehydration treatment. Thereafter, the furnace temperature is raised to 1250° C., and a mixed gas of SiF₄ of 10% by volume (flow rate: 1 slm) and helium is introduced to add fluorine. Then, the furnace temperature is further raised to 1500° C., and sintering is performed in a helium atmosphere (flow rate: 10 slm).

Next, the rod 22 is drawn out from the silica glass pipe 21, and the silica glass pipe 21 is removed by etching. As equipment, the induction furnace lathe 25 is used. In the step of removing by etching, the furnace temperature is set to 2000° C., SF₆ is introduced into the silica glass pipe 21 at a flow rate of 1 slm, and etching is performed while the furnace is traversed in a longitudinal direction of the preform at a speed of 6 mm/min. Thereby, a transparent glass preform for a cladding having a desired inner diameter can be obtained. In a comparative example in which the step of transparently vitrifying is performed without inserting the rod 22 into the silica glass pipe 21, an inner diameter is reduced to 5 mm or less, and a desired inner diameter cannot be obtained.

Next, a core pipe with an outer diameter of 39 mm is inserted inside the transparent glass preform for the cladding having a desired inner diameter, and collapsing is performed at a furnace temperature of 2000° C., a differential pressure inside the pipe of −10 kPa, and a traverse speed of 10 mm/min. Thereby, the core cladding having the core portion 11 and the cladding portion 12 is obtained.

Next, the above-described core cladding is extended to have an outer diameter of 40 mm, and jacket deposition is performed by the VAD method to obtain an optical fiber preform.

As is apparent from the above-described example, according to the manufacturing method using the silica glass pipe 21 and the rod 22, it is possible to ascertain that a transparent glass preform having a desired inner diameter can be relatively freely manufactured, and manufacturing costs can be reduced. In addition, it is possible to ascertain that an optical fiber preform having the core portion 11, the cladding portion 12, and the jacket portion 13 can be manufactured using such a transparent glass preform under less restrictive manufacturing conditions.

What is claimed is:

1. A method for manufacturing an optical fiber preform, comprising:
generating glass particles from a glass raw material gas in a flame obtained by combustion of a combustible gas supplied to a burner and depositing the glass particles on an outer circumference of a silica glass pipe to form a hollow porous glass preform;
inserting a rod into the silica glass pipe;
transparently vitrifying the porous glass preform by heating the porous glass preform after inserting the rod to obtain a transparent glass preform;
drawing out the rod from the silica glass pipe after the porous glass preform is transparently vitrified; and
removing the silica glass pipe from the transparent glass preform by etching after drawing out the rod.

2. The method for manufacturing an optical fiber preform according to claim 1, wherein the silica glass pipe has an outer diameter of 5 mm or more and 100 mm or less, and the silica glass pipe has a wall thickness of 0.5 mm or more and 5 mm or less.

3. The method for manufacturing an optical fiber preform according to claim 1, wherein an outer diameter of the rod is 4 mm or more and is smaller than an inner diameter of the silica glass pipe by 0.1 mm or more.

4. The method for manufacturing an optical fiber preform according to claim 1, wherein the rod is formed of a material having a melting point of 1500° C. or higher and a thermal expansion coefficient larger than 5×10⁻⁷/K.

5. The method for manufacturing an optical fiber preform according to claim 1, wherein the rod is formed of a material having a melting point of 1500° C. or higher and a thermal expansion coefficient larger than 1×10⁻⁶/K.

6. The method for manufacturing an optical fiber preform according to claim 1, wherein the rod is formed of one or more materials selected from alumina, carbon, silicon nitride, and silicon carbide.

7. The method for manufacturing an optical fiber preform according to claim 1,
wherein the rod has a first end and a second end opposite to the first end, and has a tapered shape which becomes thinner from the second end toward the first end, and
wherein the tapered shape has an outer diameter which decreases in a range of 0.1 mm or more and 5 mm or less per 1000 mm from the second end toward the first end.

8. The method for manufacturing an optical fiber preform according to claim 1, further comprising
inserting a core portion made of glass into an inner hole of the transparent glass preform from which the silica glass pipe has been removed in the removing; and
heating the transparent glass preform with the core portion to be integrated.
